(19) United States
(12) Patent Application Publication
(10) Pub. No.: US 2003/0199282 A1
(43) Pub. Date: Oct. 23, 2003

(54) Mobile telephone active messaging system

(76) Inventors: Cezary Marcjan, Redmond, WA (US); Andrzej Turski, Redmond, WA (US); Lili Cheng, Bellevue, WA (US)

Correspondence Address: IPSOLON LLP, 805 SW BROADWAY, #2740, PORTLAND, OR, 97205, US

(21) Appl. No.: 10/052,030

(22) Filed: Jan. 15, 2002

(51) Int. Cl. H04Q 7/20

(52) U.S. Cl. 455/466; 455/412; 455/558

(57) ABSTRACT

An active messaging system is associated with a short text messaging service of a digital cellular telephone system. An active messaging client is stored in a computer readable medium of a digital cellular telephone and provides interpretation and execution of an active message script included in a short text message received at the digital cellular telephone by radiant transmission. An active message gateway in communication with the short text messaging service receives short text messages from the digital cellular telephone and selectively forwards the short text messages according to whether they include an active message script. The active message script is a compact, high efficiency script compatible with execution on small devices with limited resources and processing power.

### TECHNICAL FIELD

The present invention relates to mobile or wireless communication devices, including digital cellular telephones, and in particular to a short text message dynamic service application for such devices.

### BACKGROUND AND SUMMARY OF THE INVENTION

Programming small mobile or wireless communication devices, like digital cellular telephones, typically requires specialized hardware or software, or access to proprietary information like authentication keys, codes, etc. As a consequence, it is typically difficult or impossible for end-users to program such mobile devices. As is known in the art, digital cellular telephones of the GSM-type include removable Subscriber Identity Modules (SIMs), which are sometimes called smart cards or chip cards. To program a GSM cellular telephone, for example, it is necessary to use a smart card programming device and a smart card programming toolkit, and to access the account authentication key, the last of which is typically not accessible except by wireless service providers. The inability of users to program or modify mobile or wireless communication devices limits the versatility and usefulness of such devices.

Moreover, some applications or services on a digital cellular telephone are accessed by a user through a “micro-browser” that runs on the telephone. The micro-browser is a greatly simplified version of a conventional network browser of the types used on personal computers. In using a micro-browser, a user must typically navigate a series of menus to access and use a service. This involves also sending and receiving a series of messages, which is time consuming and can be costly.

The present invention includes an active messaging system that is associated with a short text messaging service of a digital cellular telephone system. An active messaging client is stored in a computer readable medium of a digital cellular telephone and provides interpretation and execution of an active message script included in a short text message received at the digital cellular telephone by radiant transmission. An active message gateway in communication with the short text messaging service receives short text messages from the digital cellular telephone and selectively forwards the short text messages according to whether they include an active message script. The active message script is a compact, high efficiency script compatible with execution on small devices with limited resources and processing power.

In operation, the active message gateway forwards the short text messages that do not include an active message script to conventional the short text messaging destinations (e.g., other cellular telephones). The active message gateway interprets the active message script in the short text messages that include it and transmits any corresponding response. The active message gateway may execute the active message script or may forward it to an application server that provides the application or service corresponding to the script.

As an example, a simple real-time stock quote service may be installed on the mobile telephone as an application (service's “front end” with settings like stock symbols, etc) and added to an application menu on the mobile telephone. The user when requesting stock quotes launches the application from the application menu and receives the requested stock quotes. This is significantly faster and less expensive than when using a micro-browser. In addition, the settings for the application (stock quote symbols in this example) may be entered using a desktop computer (for example on a web site).

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 illustrates a GSM cellular telephone as an exemplary mobile wireless communication device operating environment for an embodiment of the present invention.

FIG. 2 is a functional block diagram of a text messaging system of a mobile telephone network to further illustrate an operating environment of the present invention.

FIG. 3 is a flow diagram of an active messaging gateway method that illustrates one implementation of operating an active messaging gateway.

FIG. 4 is a block diagram illustrating one implementation of active messaging gateway.

FIG. 5 is a block diagram illustrating an active messaging client system included in a mobile telephone.

FIGS. 6 and 7 are illustrations of implementations of an active message script composition user interface as rendered on a display screen of a network-connected computer.

### DETAILED DESCRIPTION OF PREFERRED EMBODIMENTS

The present invention relates to mobile or “wireless” communication devices capable of transmitting and/or receiving radiated (i.e., wireless) text messages, in some implementations of up to a maximum fixed length. Such communication devices may be implemented with various functions and in numerous forms including digital cellular telephones, portable and handheld computers, personal digital assistants, etc. The invention is described in reference to a digital cellular telephone, but is similarly applicable to other mobile or wireless communication devices that transmit and/or receive radiated fixed length text messages.

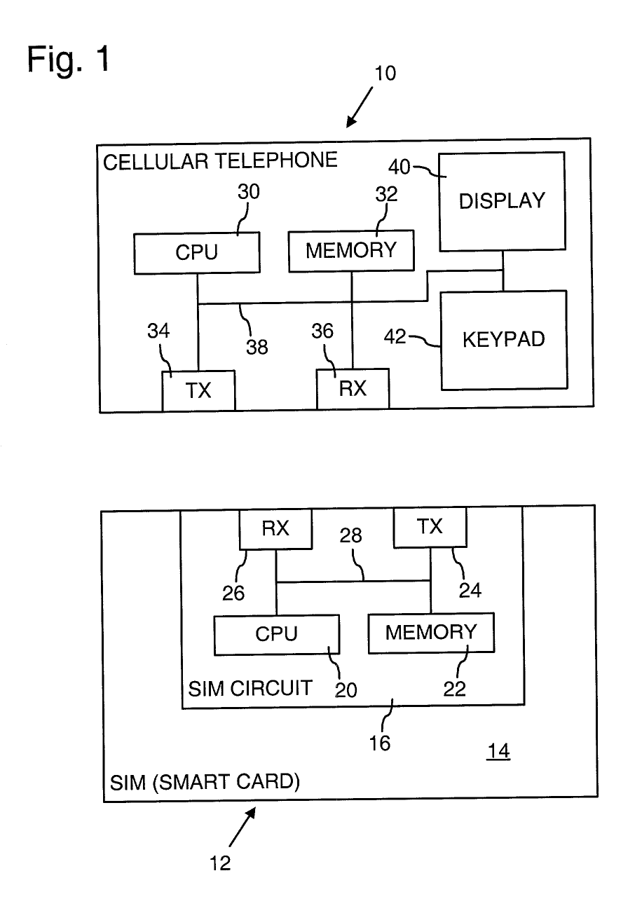

FIG. 1 illustrates a GSM cellular telephone 10 as an exemplary mobile wireless communication device operating environment for an embodiment of the present invention. GSM cellular telephone 10 may conform, for example, to the European Telecommunications Standards Institute (ETSI) specifications GSM 11.11 and GSM 11.14 for Global Systems for Mobile communications. It will be appreciated, however, that GSM cellular telephone 10 could instead conform to another communication standard or a standard not yet developed, such as the ETSI 3rd Generation Mobile System standard that is sometimes referred to as the Third Generation Partnership Project or “3GPP”.

GSM cellular telephone 10 includes a removable Subscriber Identity Module (SIM) 12, which is sometimes called a smart card or chip card. For example, SIM 12 can be of a smart card format that has the well-known size of credit cards (e.g., standardized dimensions of 53.98 mm×85.60 mm×0.76 mm), or can be of a smaller format that is sometimes called a “plug-in SIM”. SIM 12 includes a medium 14 that supports a SIM electronic circuit 16 (e.g., one or more semiconductor integrated circuits or chips).

Medium 14 typically includes multiple laminated synthetic layers, with one or more internal layers being between outer layers. SIM electronic circuit 16 is incorporated into or on at least one of the internal layers.

SIM electronic circuit 16 includes a central processing unit or CPU 20 (e.g., a microprocessor or microcontroller) in conjunction with a memory system 22, a data transmit interface 24, and a data receive interface 26, all of which are interconnected by a bus structure 28. Similarly, GSM cellular telephone 10 includes a central processing unit or CPU 30 (e.g., a microprocessor or microcontroller) in conjunction with a memory system 32, a data transmit interface 34, and a data receive interface 36, all of which are interconnected by a bus structure 38. In addition, GSM cellular telephone, 10 includes a system display 40 and a user input device or keypad 42, as well as a power supply (e.g., a battery), telephonic audio input and output elements, and radio frequency transmitting and receiving elements that are not shown.

While SIM electronic circuit 16 includes the basic elements of a simple computer, neither SIM 12 nor SIM electronic circuit 16 is capable of functioning as a stand-alone computer. Neither SIM 12 nor SIM electronic circuit 16 includes a power source nor user interface components by which a user could interact with SIM 12 or SIM electronic circuit 16. The computer functionality of SIM 12 can be accessed only by connecting it to another computer, such as GSM cellular telephone 10 or a SIM reader that is connected to a personal computer, as is known in the art. When connected to another computer, such as GSM cellular telephone 10, SIM 12 is powered and communicates through its interfaces 24 and 26 to receive data from and provide data to the other computer.

As is common, GSM cellular telephone 10 supports a fixed length text message service by which radiated (i.e., wireless) fixed length text messages of up to a maximum fixed length may be transmitted or received by GSM cellular telephone 10. As an example, the fixed length text message service could include or conform to the short message service (SMS) standard that is part of the GSM Phase 1 standard. The SMS standard allows transmission of radiated fixed length text messages of up to 160 characters in length. Such a fixed length text message service may be distinguished from conventional network connections or services in which files of generally arbitrary size may be transmitted. While referring to transmission of SMS messages, the following description may be similarly applicable to other standards or formats for radiated fixed length text messages.

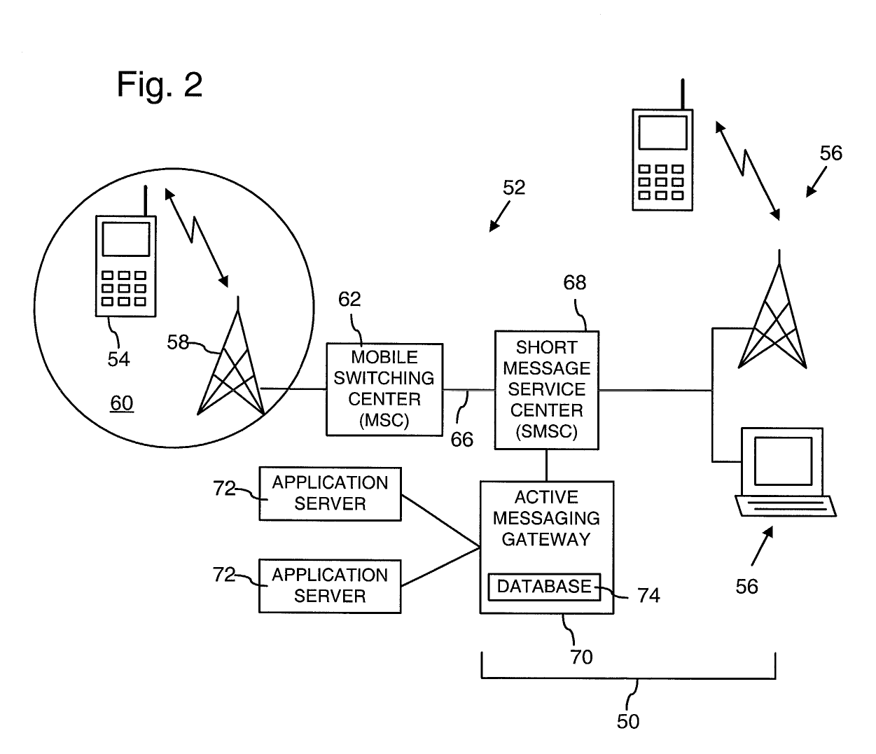

FIG. 2 is a functional block diagram of a text messaging system 50 of a mobile telephone network 52 to illustrate an operating environment of the present invention. A mobile telephone 54 compatible with active messaging of the present invention is shown as being in wireless or radiated communication with mobile telephone network 52. Mobile telephone 54 may be analogous to GSM cellular telephone 10 described above, but with additional features or components that are described below in greater detail.

Text messaging system 50 supports a short text message service by which short text messages, in some cases of up to a maximum length, may be transmitted or received by mobile telephones, such as mobile telephone 54. As an example, the short text message service could include or conform to the short message service (SMS) standard that is part of the GSM Phase 1 standard, or any other wireless communication SMS standard. One SMS standard allows transmission of fixed length text messages of up to about 160 characters in length.

Text messages are conveyed between mobile telephone 54 and another text messaging device 56 via text messaging system 50. Messaging device 56 may be of any type compatible with or employing short length text messaging, including mobile telephones, networked personal computers, handheld computing or digital devices, or any other such device. It will be appreciated that such text messages may also be transmitted between messaging devices 56 that do not include a mobile telephone 54. The description of text messaging system 50 as including mobile telephone 54 is merely an example of one configuration.

Mobile telephone network 52 includes a wireless or radiating transceiver station 58 that corresponds to a communication cell 60, and mobile telephone network may include one or more cells. Mobile telephone 54 within cell 60 communicates with mobile telephone network 52 via a wireless or radiating link with transceiver station 58. Transceiver station 58 communicates with a mobile switching center 62 that directs communications between mobile telephone 54 and various communication channels, including a public-switched telephone network channel 64 and a short text message channel 66.

Short text message channel 66 includes a short message service center 68 that is in networked communication with mobile switching center 62. Short message service center 68 generally functions to direct short text messages between mobile telephone 54 and text messaging device 56 via a computer network. Mobile switching center 62 and short message service center 68 may be located together or may be remote from each other, as is known in the art.

In one implementation, short message service center 68 directs all text messages from active messaging-compatible mobile telephone 54 to an active messaging gateway 70. Active messaging gateway 70 forwards each conventional short text message to a destination text messaging device 56 via short message service center 68.

Active messaging gateway 70 processes any active message script in text messages or forwards such messages to one or more active message application servers 72 or to a destination text messaging device compatible with active messaging of the present invention. For example, such messages may be forwarded to the destination text messaging device via short message service center 68. Active messages to be processed or executed at active message gateway 70 will typically include or contain gateway commands. Accordingly, active messaging of this invention supports both the point-to-point (P2P) interaction between mobile (e.g., cellular) telephones and client-server interaction between mobile (e.g., cellular) telephones and network-connected computers.

For example, available applications can be installed on a mobile telephone 54 registered with active messaging gateway 70 based upon user selection of an “install” command from a mobile telephone control menu. When the user selects the “Install” menu item an active message is sent requesting a list of available applications and services. Once the list is returned to mobile telephone 54 as an active message the user can select an available application or service. The selected application or service is transmitted to mobile telephone 54, as one or more active messages, and installed. From this point the application or service is available for use on mobile telephone 54 from an application menu.

It will be appreciated that mobile switching center 62, short message service center 68, active messaging gateway 70, and active message application servers 72 may each be implemented with one or more specialized or general-purpose computer systems. Such systems commonly include a high speed processing unit (CPU) in conjunction with a memory system (with volatile and/or non-volatile memory), an input device, and an output device, as is known in the art.

Active messaging gateway 70 and active message application servers 72 enable creation of active messages or applications that are distributed by wireless transmission (e.g., as SMS messages) to mobile telephones 54. Such active messaging enables programming of mobile telephones 54 and installation of distributed applications or parts of them on mobile telephones 54. The active messages may be programmed, assembled, or written by users on networked computers, as described below in greater detail.

Each mobile telephone 54 is associated with a corresponding active messaging gateway 70 that provides short message service connectivity to one or more application servers 72. In the illustrated configuration, active messaging gateway 70 communicates directly with short message service center 68. Alternatively, short message service center 68 can be configured in a private mode to use a GSM modem and a regular cellular phone as the gateway for SMS.

The private mode uses an exchange of SMS messages between two mobile telephones 54. One of these mobile telephones 54 (on the “gateway” side) is connected via a modem (not shown) with active messaging gateway 70. This allows gateway 70 to send and receive SMS messages without the need to be connected directly to the SMS service center 68. An advantage of this configuration is that it allows for development and testing of the active messaging system of this invention without direct connection to SMSC 68 (i.e. without direct involvement of the mobile telephone company, other then the security keys to reprogram mobile telephones). This allows the active messaging system to be tested and even deployed without compromising SMSC security and stability.

Active messaging gateway 70 maintains a database 74 of registered mobile telephones 54, active message applications, and registered application servers 72 that have permission to connect to gateway 70 and perform authorized actions. Database 74 also includes indications of the access privileges of mobile telephones 54 and application servers 72. With reference to database 74, active messaging gateway 70 performs authentication of access requests made by mobile telephones 54 and application servers 72.

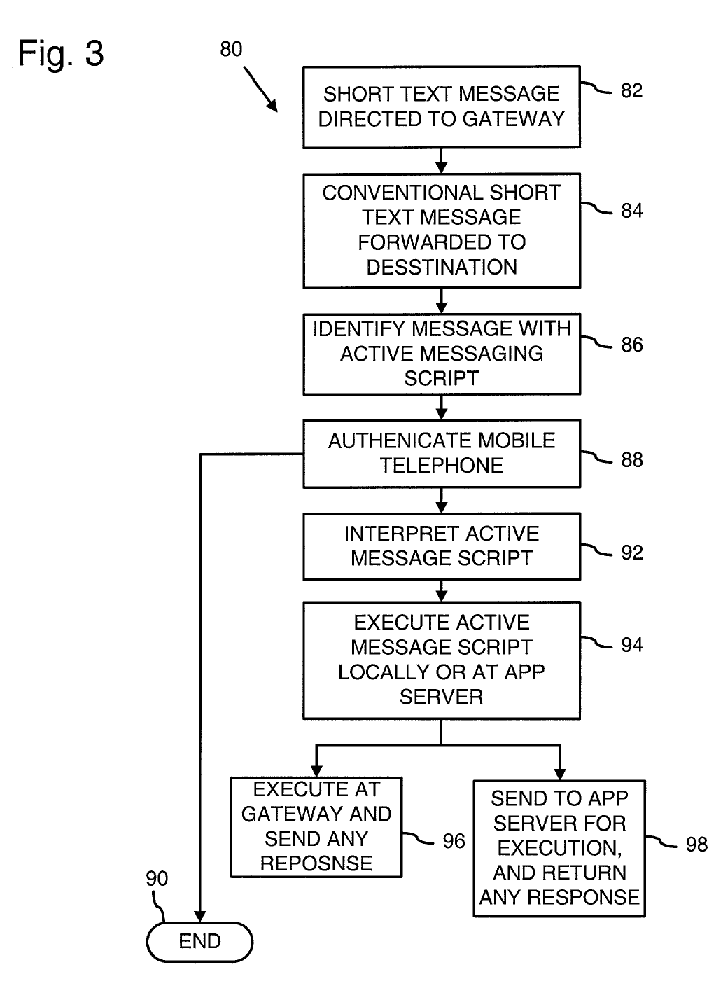

FIG. 3 is a flow diagram of an active messaging gateway method 80 that illustrates one implementation of the operation of gateway 70. Active messaging gateway method 80 may be implemented by corresponding software operated on gateway 70.

Process block 82 indicates that short text messages transmitted from an associated active messaging-compatible mobile telephone 54 are directed to active messaging gateway 70.

Process block 84 indicates that each received conventional short text message is forwarded to its destination text messaging device 56 via short message service center 68.

Process block 86 indicates that short text messages with active messaging script received from the associated active messaging-compatible mobile telephone 54 are identified.

Process block 88 indicates that active messaging-compatible mobile telephone 54 is authenticated as being associated with the active messaging gateway 70. For example, the active messaging gateway 70 authenticates the active messaging-compatible mobile telephone 54 by referencing database 74. If mobile telephone 54 is not authenticated as being associated with gateway 70, process block 88 proceeds to termination block 90 and, optionally, an indication that the active message has been terminated may be returned to mobile telephone 54. If mobile telephone 54 is authenticated as being associated with gateway 70, process block 88 proceeds to process block 92.

Process block 92 indicates that the active message script is interpreted.

Process block 94 indicates that a determination is made as to whether the interpreted active message is to be executed locally at gateway 70 or at an application server 72 registered with gateway 70. For example, the determination may be made by obtaining from database 74 an indication of where a service or application requested by the active message is performed. If the service or application requested by the active message is to be performed by gateway 70, process block 94 proceeds to process block 96. If the service or application requested by the active message is to be performed by an application server other than gateway 70, process block 94 proceeds to process block 98.

Process block 96 indicates that the service or application requested by the active message script is performed by gateway 70 and a response, if required, is transmitted to the associated mobile telephone 54.

Process block 98 indicates that the service or application requested by the active message is transmitted to the application server 72 and a response, if required, is transmitted back to the associated mobile telephone 54 via gateway 70. In one implementation, for example, gateway 70 re-formats the active message request, such as into an XML format, before sending it to the application server 72. Likewise, application server 72 may transmit any required response to gateway 70 in the same format (e.g., XML), and gateway 70 reformats the response into a format compatible with the active messaging of mobile telephone 54.

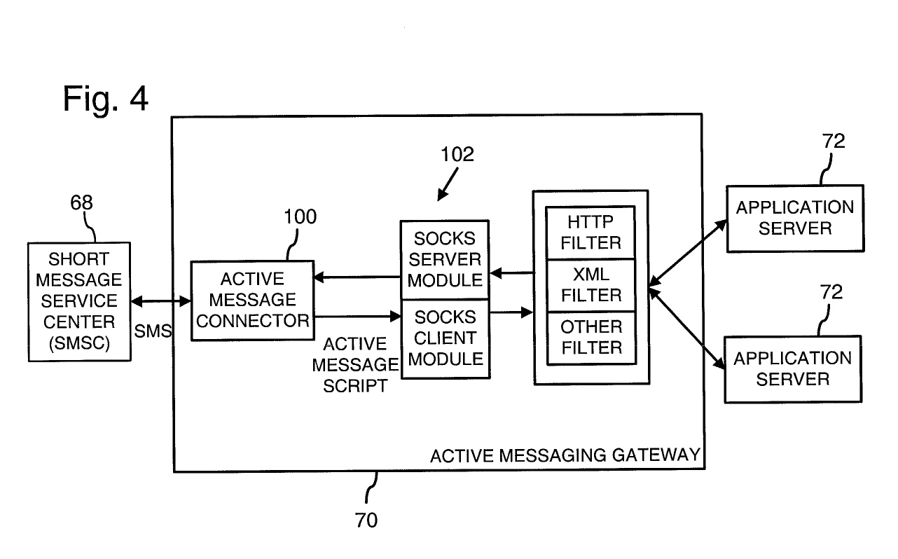

FIG. 4 is a block diagram illustrating one implementation of active messaging gateway 70. An active messaging connector service 100 provides communication between short message service center 68 and client/server components 102 that provide an active message service interface 104 to one or more application servers 72.

Active messaging connector service 100 may communicate with short message service center 68 in accordance with the TCP/IP protocol using a sockets interface. As is known in the art, sockets is a method for communication between a client program and a server program in a network. A socket is defined as “the endpoint in a connection.” Sockets are created and used with a set of programming requests or “function calls” sometimes called the sockets application programming interface (API).

Communication with the one or more application servers 72 may be made via one or more file format filters 106 (e.g., HTTP filter 86A and XML filter 86B shown). File format filters 106 are used to translate active messages into standard Internet formats and protocols. While it is possible to develop application servers 72 so that they communicate with gateway 70 using the binary active messaging script and direct calls to APIs or any other proprietary protocols, the use of standard Internet protocols simplifies development and communication and allows for the placement of gateway 70 and application servers 72 in different physical locations. The latter allows, for example, gateway 70 to be placed at a mobile telephone company facility and the application servers 72 to be hosted by application providers other than the mobile telephone company.

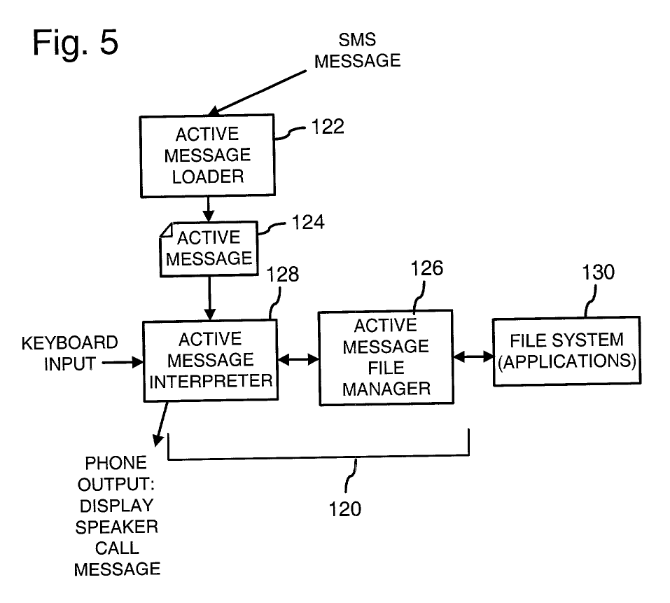

FIG. 5 is a block diagram illustrating an active messaging client system 120 included in mobile telephone 54. For example, active messaging client system 120 may be embedded within an operating system on a SIM 12 of a GSM-standard telephone. It will be appreciated, however, that active messaging components 120 could alternatively be implemented in or associated with other mobile telephone components and in mobile telephones based upon standards other than GSM.

Active messaging client system 120 includes an active messaging loader 122 that identifies active messages 124 received at mobile telephone 54 via a short message service and forwards the and active messages to an active message interpreter 128. In this implementation, active messages 124 are transmitted via a short message service and include active message script that can be executed. The active message script is a compact, high efficiency script compatible with execution on small devices with limited resources and processing power. An active message application is an executable program that is written using the active message script.

Active messaging loader 122 identifies active messages 124 and distinguishes them from conventional short text messages by, for example, header information that is included in each active message but not included in conventional short text messages. Active messaging loader 122 delivers active messages 124 to an active message file manager 126 for storage or to an active message interpreter 128 to be executed. Active messaging loader 122 delivers conventional short text messages to SIM 12, for example, for storage in accordance with conventional text message system operations.

An active message file manager 126 maintains active message applications and services that are stored in a file system 130 on mobile telephone 54 (e.g., stored on a SIM 12 of a GSM-standard telephone). File manager 126 adds, removes, and renames active message applications. An active message interpreter 128 interprets and executes the active message script included in active message 124. Active message interpreter 128 receives the script directly from active messaging loader 122 or from file manager 126 when applications are executed from the phone menu.

Active messaging of this invention can support or implement a wide range of applications on mobile telephone 54. One simple class of exemplary applications is interactive guides. The active message scripts for these types of applications, once downloaded to and installed on mobile telephone 54, may be executed entirely within mobile telephone 54. An example of such a script is a troubleshooting guide, which can offer a user context-sensitive advice based on previous user responses.

A more advanced class of exemplary applications is helpdesk calls. These may be considered extensions to troubleshooting applications in that they can seek human technician help with more complex issues by placing a live call to a helpdesk technician. The script can choose an appropriate telephone number to call based on an earlier problem diagnosis. A similar class of application is voting systems or tests/examinations in which user responses are collected and sent to an application server 72 for processing.

In the above examples, the active message script can be previously installed on active messaging gateway 70 and then downloaded to mobile telephone 54 by the end user and executed once per session. Alternatively, the active message script may be sent to mobile telephone 54 as an active message to be executed immediately upon receipt. In one implementation the active message script may be sent as a response to the user calling a specific phone number. This can be compared to conventional voice response systems in which a user calls a number and navigates through a sequence of voice prompts using phone keys. An advantage of active messaging of this invention is that the script can be offline, which saves on connection charges and reduces reliance on network connectivity. Also, immediate on-screen feedback can ensure a better accuracy of written responses.

As another example, an active message may simply contain a command to rerun a prior active message script, or a different previously-installed one, with a different starting parameter. This is could be useful in a peer-to-peer scenario and could correspond to an on-going negotiation between two users. This may be useful for business negotiations (e.g., auctions) and for turn-based games like chess.

Typically, the most complex class of active message applications would involve two-way communication with an application server 72. This is a classic client-server scenario with application server 72 handling communications with any other mobile telephone clients or other networked computer resources. In this client-server model, each execution of an active message script on mobile telephone 54 can create an opportunity for some user interaction. Results are then sent for processing to application server 72, which can respond with another active message containing another active message script to be executed on mobile telephone 54. Such exchanges between mobile telephone 54 and application server 72 can go back and forth several times.

In this model, mobile telephone 54 serves the role of a remote user interface device, with each run of active message script similar to a single dialog in a windowed personal computer environment. By offloading data processing to application server 72, distributed applications of arbitrary complexity can be created to use only minimal processing power on mobile telephone 54.

Active message scripts can also be run in a silent mode in which no user interaction required. Such a mode is particularly useful for background tasks, such as status checks or location queries.

The active message script is a simplified programming language appropriate for the limited resources of SIMs 12 and mobile telephones 54. Script instructions can be divided into three groups: user interface elements, control elements, and instructions to access phone resources.

In one implementation, three user interface elements are supported by the active message script: a simple instruction to print text on a mobile telephone display screen, which can be followed by Yes/No choice; a list box, which allows for a user selection from the list of predefined items; and an edit field, which allows for an arbitrary user input.

In one implementation, the set of control statements includes a string comparison, conditional and unconditional jumps, and auxiliary instructions to clear buffers and set an application name. This narrow set of control statements suits the limited processing and storage capacity of a conventional SIM 12 in GSM mobile telephone. It will be appreciated, however, that this narrow set of control statements could readily be expanded.

The auxiliary instructions to clear buffers refer to one or more buffers that may be included in or used by active message interpreter 128. For example, active message interpreter 128 may have two 256 byte long string buffers for processing control statements and instructions: a global buffer (GB) that is a string of bytes used for building text sequences, responses, etc. and a last result buffer (LRB) that is used for storing the last result. In addition, active message interpreter 128 may include a 256 byte long temporary buffer that is used for transferring data between instructions and separate applications.

The instructions for handling interactions with mobile telephone hardware may utilize an underlying mobile telephone or SIM operating system. In one implementation, the instructions include a command to send a short text message, a command to place a voice call, a command to access a telephone address book, and a command to obtain the mobile telephone location (e.g., by obtaining the associated cell identifier).

The active message script is designed for interpretation on a mobile telephone (e.g., a SIM 12 of a GSM digital cellular telephone 10), or any similar electronic device having analogous wireless communication capabilities. Accordingly, the active message script is configured to be compact to be compatible with the limited processing and storage resources of such devices. Likewise, the active message script is configured to be efficient to parse. Since searching for a character or a string of bytes is computationally expensive, all text strings in one implementation are prefixed with their byte-size and all jumps are made to specific byte locations within the script (no labels, etc.). The script interpreter is also configured to be of minimal size.

All instructions have the following format:

<Instruction><Flags>[<Data>][<Address>]

The <Instruction> field is one byte in size specifies the command to execute by the SIM. Each instruction described below is shown as an ASCII character that represents the corresponding character code (example: A=0×41). The <Flags> field is one byte in size, specifies options for the command. The <Address> field is two bytes in size. It is a byte-address of an instruction to be executed in certain conditions depending on the command (for example, on “cancel” button). The following instructions for the <Instruction> byte are available:

```
PRINT
Print text.
P<Flags><Size>[<Text>][<InstrOnCancel>]
<Flags>:
0x01 - print to GB (append to GB) (default: screen)
0x02 - print to LRB (default: screen)
0x04 - text from GB (default: <Text>)
0x08 - text from LRB (default: <Text>)
<Size>:
Size in bytes of the optional <Text>. If the <Text> field is empty
then the value is 0x00
<InstrOnCancel>
This is address of the Instruction to go to when the “cancel” button
is selected. This is included only when printing to screen.
Example:
P%00%05Harry%01%2F - (<Flags>=0x00, <Size>=0x05,
<InstrOnCancel>=0x012F) print the text “Harry”, on the cell
phone's screen. When user selects the “cancel” button the
execution continues at the byte location 0x012F.
INPUT
Ask for user's input. Print the specified text (or text from GB or
LRB depending on <Flags>) and store the entered text in LRB.
I<Flags><Size>[<Text>]<InstrOnCancel>
<Flags>:
    0x01 - print the contents of GB (default: <Text>)
    0x02 - print the contents of LRB (default: <Text>)
    0x04 - append the entered text to GB (default: no)
<Size>:
Size in bytes of the optional <Text>. If the <Text> field is empty
then the value is 0x00
Example:
I%00%11 Enter your name: %01%2F—(<Flags>=0x00,
<Size>=0x11, <InstrOnCancel>=0x012F) print the text “Enter your
name:”, on the cell phone's screen. Store the entered text in LRB.
When user selects the “cancel” button the execution continues at
the byte location 0x012F.
SELECT
Ask the user to select an item from the list.
S<Flags>[<Size1><Text1><Size2><Text2>...]0x00<InstrOnCancel>
<Flags>:
0x01 - return text of selected item (default: index of an item
starting at 1)
0x02 - append the result to GB (default: no)
0x04 - the items list consists of names in address book +
specified items.
<SizeX>:
Size in bytes of the optional <TextX>. If the <TextX> field is empty
then the value is 0x00 (this is also list terminating field).
Example:
S%03%04Book%03Pen%0BScotch Tape%00%01%2F -
(<Flags>=0x03, <Size1>=0x04, <Size2>=0x03, <Size3>=0x0B,
<InstrOnCancel>=0x012F) Select one of the specified items and
append the text of the selected item to GB. Store the entered text
also in LRB. When user selects the “cancel” button the execution
continues at the byte location 0x012F.
CONDITION
Compare two items (byte strings) and jump to the specified
address when items are equal.
?<Flags><Size><Text><Address>
<Flags>:
0x01 - compare the specified <Text> to GB (default: compare with
LRB)
0x02 - jump to specified address if items are not equal (default:
jump when equal)
<Size>:
Size in bytes of <Text>.
Example:
?(0)(4)Book(12F) - (<Flags>=0x00, <Size>=0x04,
<Address>=0x012F). Jump to the byte 0x012F of the script if the
text in LRB is “Book”.
SEND MESSAGE
Send SMS message (send the contents of GB).
M<Flags><Size><Text><Address>
<Flags>:
0x01 - lookup a name in the address book (default: LRB or
<Text> is phone#)
0x02 - LRB contains the name or number to call (default:
<Text> field)
<Size>:
Size in bytes of <Text>.
<Address>:
Byte address to jump to in case of error sending SMS.
Example:
M%01%05Harry%01%2F - (<Flags>=0x01, <Size>=0x05,
<Address>=0x012F). Send the contents of GB as an SMS
message to Harry (lookup his phone number in the address book).
Jump to the byte 0x012F of the script if there was an error sending
SMS.
CALL
Initialize a phone call to the specified person.
C<Flags><Size><Text><Address>
<Flags>:
    0x01 - lookup a name in the address book (default: LRB or
<Text> is phone#)
    0x02 - LRB contains the name or number to call (default:
<Text> field)
<Size>:
Size in bytes of <Text>.
<Address>:
Byte address to jump to in case user cancels the phone call.
Example:
C%01%05Harry%01%2F - (<Flags>=0x01, <Size>=0x05,
<Address>=0x012F). Call Harry (lookup his phone number in the
address book). Jump to the byte 0x012F of the script if there was
an error sending SMS.
LOCATION
Get cell phone location information
L<Flags><Address>
<Flags>:
    0x01 - append the location information to GB (default: no,
send only to LRB).
<Address>:
Byte address to jump to in case of error (can't get the location).
Example:
L%00%01%2F - (<Flags>=0x00, <Address>=0x012F). Append
the location information to GB. Jump to the byte 0x012F of the
script in case of error.
EXECUTE
Execute script from the specified file starting at the first byte.
X<Flags><Size><Text><Address>
<Flags>:
    0x01 - LRB contains the file name (default: <Text>).
<Address>:
Byte address to jump to in case of error in execution of the script.
Example:
X%00%07/1234.a%01%2F - (<Flags>=0x00, <Size>=0x07,
<Address>=0x012F). Execute the script stored in the file “/1234.a”.
Jump to the byte 0x012F of the script in case of error.
GOTO
Go to specified byte location within the script.
G<Address>
<Address>:
Byte address to jump to.
CLEAR
Clear LRB and GB buffers
R<Flags>
<Flags>:
    0x01 - not LRB.
    0x02 - not GB
ADDRESSBOOK
Address book operation. Get or read first, next, current entry fields
(name, phone number, status). The result is stored in LRB.
A<Flags><Size><Value><Address>
<Flags>:
    0x01 - First entry (default: current)
    0x02 - Next entry (default: current)
    0x04 - Name (default: phone number)
    0x08 - Status (default: phone number)
    0x10 - Write operation (default: read)
<Size>:
    Specifies the size (in characters) of <Value> entry.
<Value>:
    Value to use for the operation (for write operations)
<Address>:
Byte address to jump to on error.
Example:
A%10%00Harry-cell%7F%7F - Set the name field of the current
record to the text “Harry-cell”. This text is also stored in LRB after
this operation.
APPLICATION
This is a command that sets the LRB to the application name. This
command must be first in the script. It is used by the active
messaging gateway to specify application for some built-in
services (like 1x - get application script).
A<ID><Size><AppName>
<ID>:
    ID of the application - size is two (2) characters.
<Size>:
    Size (in bytes) of the application name
<AppName>:
    Name of the service/application specified
Example:
AHW%10HelloWorld
—Application/service named “HelloWorld” with ID “HW”.
TEXT
This command is used for description of a text field used as
parameters for some commands.
T<Size><Text>
<Size>:
    Size (in bytes) of the application name
<Text>:
    Text field
Example:
T%10HelloWorld
```

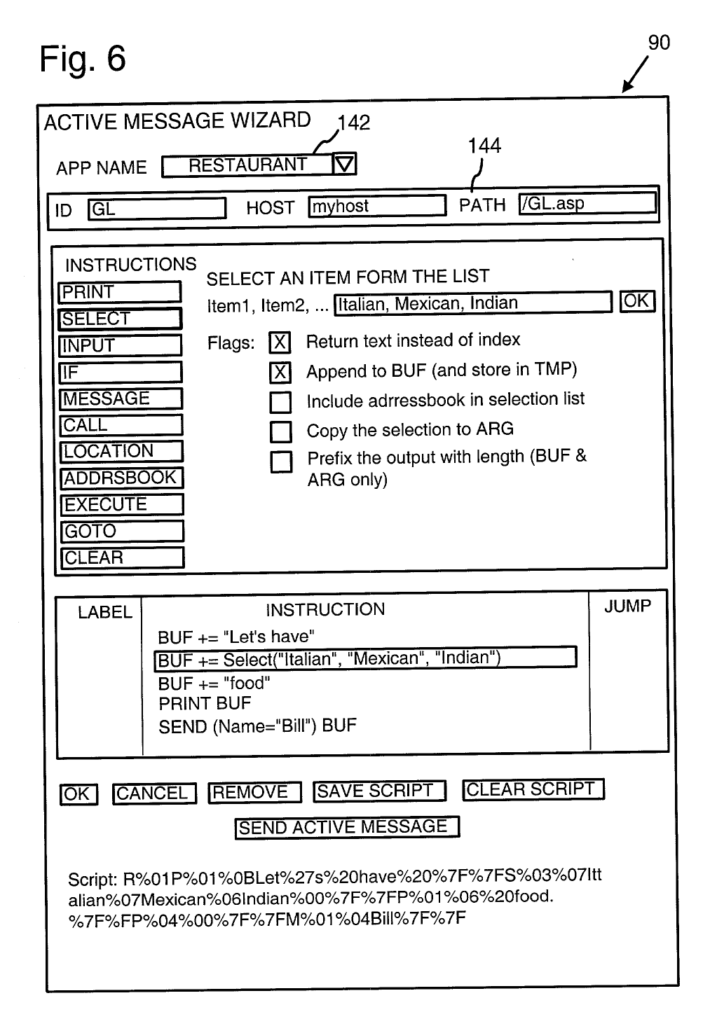

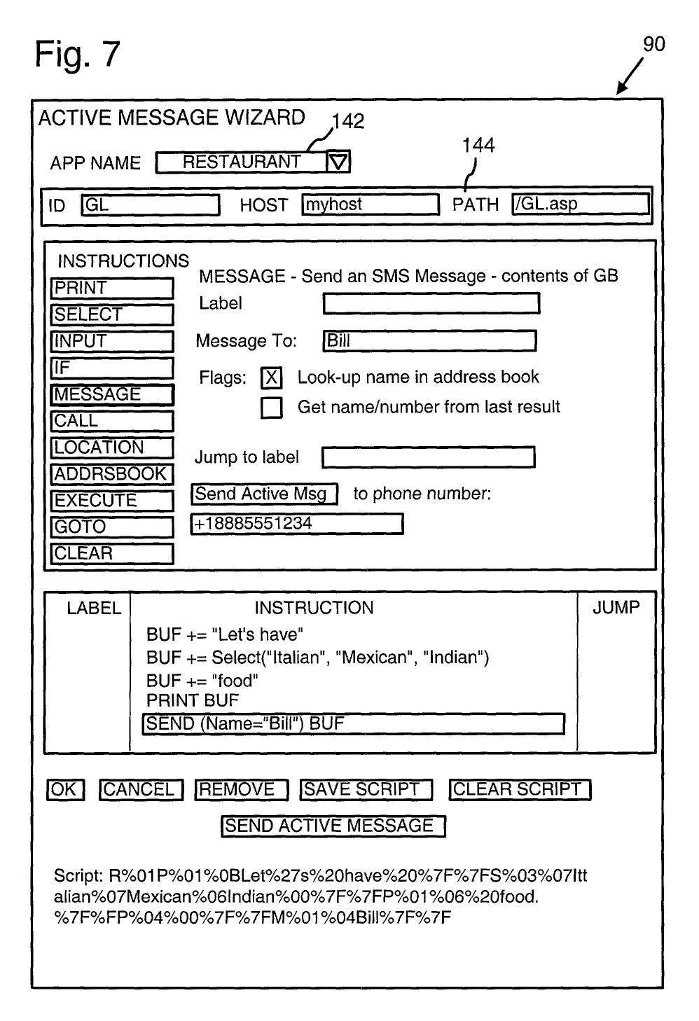

FIGS. 6 and 7 are illustrations of implementations of an active message script composition user interface 140 as rendered on a display screen of a network-connected computer. Active message script composition user interface 140 is rendered by active message script composition software, sometimes called a wizard, that assists users with composing active messages or applications based upon the active message script. It will be appreciated, therefore, that the active message script composition software would function generally as a compiler.

For example, active message script composition user interface 140 may be provided by the active message script composition software over a network (e.g., over the Internet as a Web page) to the personal computer for use by a user. User interface 140 includes an applications listing 142, represented in this implementation as a drop-down menu, that lists active message applications that are available to the user. A “Restaurant” application is illustrated. Once composition of an application is complete, the application may be assigned identifying information in an application identification window 144 that may include an application ID, an indication of a host computer where the application is to be stored, and a path indication specifying the location of the application on the host.

Each application includes a set of commands or instructions. User interface 140 includes an application commands display 146 that lists commands included in the application indicated or selected in applications listing 142. The commands in application commands display 146 may be represented in the form of a simple sequential listing (as shown) or as a tree structure. A command edit window 148 allows a user to select or specify features or characteristics of a command selected in application commands display 146. The commands of the Restaurant application function to send to another user Bill an active message requesting that he select the type of restaurant (Italian, Mexican, Indian) to be visited by the two users.

FIG. 6 illustrates command edit window 148 as configured for a “select” command (as described above) that is to be loaded into a buffer (BUF). FIG. 7 illustrates command edit window 148 as configured for a “send” command (as described above) that is to transmit the active message to a specified other user. An active message script window 150 displays active message script provided by the active message script composition software as the application specified by the user.

In addition to execution of active messages or active message applications, mobile telephone 54 also includes active message communication with gateway 70 to provide and control the exchange of between them and between any application servers 72. Active message communications between mobile telephone 54 and its corresponding gateway 70 may include active message header information that is included within the header of short text message communications, such as those conforming to GSM-based Short Message Service communications. In one implementation the active message header information may be of the form:

```
[CellToGatewayCode][Msg#][MsgOf][ACK][AppID][AppData][Script]
in which:
[CellToGatewayCode] - one byte, value is 0x08
[Msg#] - one byte, Message number
[MsgOf] - one byte, total number of messages to complete the
request
[ACK] - one byte, flag notifying the gateway to send (or not) the
acknowledgement
[AppID] - two bytes, application/service ID, first byte must be
      an ASCII code of a letter, digits are reserved for
      internal services
[Script] - application/service active message script (in the raw
binary format)
```

Communications between mobile telephone 54, active message gateway 70, and an application server 72 may take the form of requests directed to active message gateway 70 and responses directed to mobile telephone and application server 72, as follows:

```
<AMessage>
  <Request>
    ...
  </Request>
  <Request>
    ...
  </Request>
  ...
  <Response>
    ...
  </Response>
  <Response>
    ...
  </Response>
  ...
</AMessage>
```

The preparation and installation of an active messaging application may be considered a 3-step process.

In a first step, active message application code is developed by an application service provider (e.g., an individual or a company). The active message application will typically include part written in the active messaging script (and destined to be executed on mobile telephones 54), and may also include an application server part that can be developed using standard computer development techniques. Active messaging script can be coded directly in binary (e.g., using script definitions listed and described above), or can be developed more easily by using a higher-level development tool or “wizard” like the one described above with reference to FIGS. 6 and 7 (i.e., the active message script composition software).

In a second step, the ready and compiled active message script is installed on active message gateway 70 using, for example, an InstallService command, which is described below in greater detail. This installation stores the service represented by the active messaging script in database 74 of gateway 70, making the active message script publicly available for download to mobile telephones 54. The active message script composition software described above with reference to FIGS. 6 and 7 could function to send the InstallService command and install the active message script on the gateway 70 automatically.

In a third step, a user interested in using a particular service selects it from a menu of available active message services displayed on mobile telephone 54. For example, the menu may be a list of services that are available from gateway 70, the list being provided to the mobile telephone 54 in response to a GetServiceList command, which is described below in greater detail. Upon selection of a service, the corresponding active message script is downloaded to file system 130 of mobile telephone 54 using for example a GetService command, which is described below in greater detail. Once downloaded to file system 130 of mobile telephone 54, the service becomes available mobile telephone 54.

As the above description indicates, active messaging scripts may be stored in either or both of two separate stores: database 74 at gateway 70 and file system 130 of mobile telephone 54. Storage on mobile telephone 54 is handled by active message file manager 126, which allows script to be to added, removed, or executed.

Various commands are used to communicate with and administer gateway 70 and database 74. As outlined above, for example, GetServiceList and GetService commands may be used by active message loader 122 of mobile telephone 54 to obtain a list of services available from gateway 70 and to install on mobile telephone 54 the active message script of a selected service, respectively. Also, a SendActiveMessage command may be used to send active messages to any destination, including gateway 70, application servers 72, and other mobile telephones 54.

Some gateway commands are intended for the gateway administration and would only rarely, if ever, be sent from mobile telephone 54. These commands would typically be sent from an administrative tool like the active message script composition software described above with reference to FIGS. 6 and 7. For example, gateway database 74 is managed by gateway 70 and may be controlled with such gateway commands. Specifically, an InstallService command can add a service to gateway database 74, and a DeleteService command can remove a service from gateway database 74.

Other gateway commends can also apply to gateway operations rather than to mobile telephone connection. For example, GetUserList, GetUser, and AddUser commands can get or modify information about user rights stored at gateway database 74, such as in connection with active messaging security described with reference to process block 88 of FIG. 3. Also, SaveSettings and LoadSetting commands can save and load gateway settings (e.g., in the form of XML file), and a StopGateway command can stop a service operating on gateway 70 (i.e., shutting down the service remotely).

It will be appreciated that these commands are merely illustrative of one implementation of the present invention. The SaveSettings, LoadSettings, and StopGateway commands, for example, may be considered auxiliary or optional commands. Control of gateway 70 and its database 74 can be maintained in many other ways.

As indicated above, scripts and communications directed to or from mobile telephone 54 will utilize a compact and efficient active messaging script. With greater processing, storage and bandwidth capabilities, the corresponding communications to and from applications servers 72 may utilize a more conventional format which, in the implementation illustrated below, is expressed as XML schema. One implementation of formats and structures for the GetServiceList, GetService, InstallService, DeleteService, GetUserList, GetUser, AddUser, DeleteUser, SendActiveMessage, SendMessage, SaveSettings, LoadSettings, StopGateway commands are set forth below in greater detail.

GetServiceList (XML):

| | |
|---|---|
| Request | <AMessage> |
| | <Request> |
| | <Method>GetServiceList</Method> |
| | <Inst>555555</Inst> |
| | <Params> |
| | <Item>Name</Item> |
| | <Item>ID</Item> |
| | <Item>Description</Item> |
| | ... |
| | </Params> |
| | </Request> |
| | </AMessage> |
| Response | <AMessage> |
| | <Result> |
| | <Method>GetServiceList</Method> |
| | <Inst>555555</Inst> |
| | <Value> |
| | <Error> |
| | ERROR_CODE |
| | <Description>...</Description> |
| | </Error> |
| | <Service> |
| | <Name>...</Name> |
| | <ID>...</ID> |
| | <Description>...</Description> |
| | ... |
| | </Service> |
| | <Service> |
| | <Name>...</Name> |
| | <ID>...</ID> |
| | <Description>...</Description> |
| | ... |
| | </Service> |
| | ... |
| | </Value> |
| | </Result> |
| | </AMessage> |

GetServiceList (Active Message Script—Encoded):

| | |
|---|---|
| Request | %07%01%01N10%xx |
| | %xx - service index to start the list with (first=%01) |
| Response | If all services fit in one message: |
| | %07%01%01N10S%01%L1ServiceName- |
| | 1%L2ServiceName2...%00%7F%7F |
| | X%00%03/10%7F%7F |
| | In case of partial list (not all services fit in one message): |
| | %07%01%01N11%nnS%01%L1ServiceName- |
| | 1%L2ServiceName2...%00%7F |
| | %7F |
| | X%00%03/11%7F%7F |
| | ServiceName1, ServiceName2, ... - service names |
| | %nn - index of first service that is not included in the list |
| | %L1, %L2, ... - length (in characters) of each service name |

GetService (XML):

| | |
|---|---|
| Request | <AMessage> |
| | <Request> |
| | <Method>GetService</Method> |
| | <Inst>555555</Inst> |
| | <Params> |
| | <ID>...</ID> |
| | ... |
| | </Params> |
| | </Request> |
| | </AMessage> |
| Response | <AMessage> |
| | <Result> |
| | <Method>GetService</Method> |
| | <Inst>555555</Inst> |
| | <Value> |
| | <Error> |
| | ERROR_CODE |
| | <Description>...</Description> |
| | </Error> |
| | <Service> |
| | <Name>...</Name> |
| | <ID>...</ID> |
| | ... |
| | </Service> |
| | ... |
| | </Value> |
| | </Result> |
| | </AMessage> |

GetService (Active Message Script—Encoded):

| | |
|---|---|
| Request | Get service script: |
| | %07%01%01N20a%00%00%ss<SvcName> |
| | %ss - length in characters of the name |
| | Get service property: |
| | %07%01%01N22t%ss<SvcName>t%ss<PropertyName> |
| | or: |
| | %07%01%01N23t%ss<SvcName>t%ss<PropertyName> |
| | SvcName - name of the service |
| | PropertyName - Name of the requested property value. Property name could |
| | be: |
| | Description, ID, Name, Host, Path, Author, ... |
| Response | Get service script (command 20): |
| | %07%01%01N20a<ID>%ss<SvcName><Script> |
| | ID - ID of the service/application (two characters) |
| | %ss - length in characters of the name |
| | SvcName - name of the service |
| | Script - script of this service/application |
| | If the script doesn't fit in one message then the second and the following |
| | messages do not use the ‘a’ instruction. |
| | The service is added to the menu |
| | Get service script (command 21): |
| | Same as command 20 above except that the service is not added to the menu. |
| | Get service property (command 22): |
| | %07%01%01NAMP%00%ss<PropertyName> of <SvcName>: |
| | <PropertyValue>%7F%7F |
| | PropertyName - Name of the requested property. |
| | SvcName - name of the service |
| | %ss - length in characters of the printed message |
| | Get service property (command 23): |
| | %07%01%01N23a<ID>%ss<AvcName>t%ss<PropName>t%ss<PropValue> |

InstallService (XML):

| | |
|---|---|
| Request | <AMessage> |
| | <Request> |
| | <Method>InstallService</Method> |
| | <Inst>555555</Inst> |
| | <Params> |
| | <Service> |
| | <Name>...</Name> |
| | <ID>...</ID> |
| | <Host>...</Host> |
| | <Path>...</Path> |
| | <Description>...</Description> |
| | <Script>...</Script> |
| | ... |
| | </Service> |
| | ... |
| | </Params> |
| | </Request> |
| | </AMessage> |
| Response | <AMessage> |
| | <Result> |
| | <Method>InstallService</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

InstallService (Active Message Script—Encoded):

| | |
|---|---|
| Request | %07%01%01N30a<ID>%ss<SvcName> |
| | %ss - length in characters of the name |
| Response | %07%01%01N20a<ID>%ss<SvcName> |

DeleteService (XML):

| | |
|---|---|
| Request | <AMessage> |
| | <Request> |
| | <Method>DeleteService</Method> |
| | <Inst>555555</Inst> |
| | <Params> |
| | <ID>...</ID> |
| | <Name>...</Name> |
| | </Params> |
| | </Request> |
| | </AMessage> |
| | Note: both ID and Name must match to delete the service. |
| Response | <AMessage> |
| | <Result> |
| | <Method>DeleteService</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

DeleteService (Active Message Script—Encoded):

| | |
|---|---|
| Request | %07%01%01N40aID%ss<SvcName> |
| Response | No response |

GetUserList (XML):

| | |
|---|---|
| Request | <AMessage> |
| | <Request> |
| | <Method>GetUserList</Method> |
| | <Inst>555555</Inst> |
| | <Params> |
| | <Item>Name</Item> |
| | <Item>EMail</Item> |
| | ... |
| | </Params> |
| | </Request> |
| | </AMessage> |
| Response | <AMessage> |
| | <Result> |
| | <Method>GetUserList</Method> |
| | <Inst>555555</Inst> |
| | <Value> |
| | <Error> |
| | ERROR_CODE |
| | <Description>...</Description> |
| | </Error> |
| | <User> |
| | <Name>...</Name> |
| | <EMail>...</EMail> |
| | ... |
| | </User> |
| | <User> |
| | <Name>...</Name> |
| | <EMail>...</EMail> |
| | ... |
| | </User> |
| | ... |
| | </Value> |
| | </Result> |
| | </AMessage> |

GetUserList (Active Message Script—Encoded):

| | |
|---|---|
| Request | %07%01%01N50%xx |
| | %xx - user index to start the list with (first=%01) |
| Response | If all users fit in one message: |
| | %07%01%01NAMS%01%L1UserName1%L2UserName2... |
| | %00%7F%7F |
| | X%00%03/50%7F%7F |
| | In case of partial list (not all users fit in one message): |
| | %07%01%01N51%nnS%01%L1UserName1%L2- |
| | UserName2...%00%7F%7F |
| | UserName1, UserName2, ... - user names |
| | %nn - index of first user that is not included in the list |
| | %L1, %L2, ... - length (in characters) of each name |

GetUser (XML):

| | |
|---|---|
| Request | <AMessage> |
| | <Request> |
| | <Method>GetUser</Method> |
| | <Inst>555555</Inst> |
| | <Params> |
| | <Name>...</Name> |
| | </Params> |
| | </Request> |
| | </AMessage> |
| Response | <AMessage> |
| | <Result> |
| | <Method>GetUser</Method> |
| | <Inst>555555</Inst> |
| | <Value> |
| | <Error> |
| | ERROR_CODE |
| | <Description>...</Description> |
| | </Error> |
| | <User> |
| | <Name>...</Name> |
| | <Permissions> |
| | <Admin> |
| | <ReadUsers>YES\|NO</ReadUsers> |
| | s> |
| | <WriteUsers>YES\|NO</WriteUsers> |
| | s> |
| | </Admin> |
| | <Service> |
| | <ID>...</ID> |
| | <Read>YES\|NO</Read> |
| | <Write>YES\|NO</Write> |
| | <Execute>YES\|NO</Execute> |
| | </Service> |
| | <Service> |
| | <ID>...</ID> |
| | <Read>YES\|NO</Read> |
| | <Write>YES\|NO</Write> |
| | <Execute>YES\|NO</Execute> |
| | </Service> |
| | ... |
| | </Permissions> |
| | <EMail>...</EMail> |
| | <Host>...</Host> |
| | <Description>...</Description> |
| | ... |
| | </User> |
| | </Value> |
| | </Result> |
| | </AMessage> |

GetUser (Active Message Script—Encoded):

| | |
|---|---|
| Request | Get user property: |
| | %07%01%01N60t%ss<UserName>t%ss<PropertyName> |
| | or: |
| | %07%01%01N61t%ss<SvcName>t%ss<PropertyName> |
| | UserName - name of the user |
| | PropertyName - Name of the requested |
| | property value. Property name could |
| | be: |
| | Description, EMail, Host, ... |
| Response | Get user property (command 60): |
| | %07%01%01NAMP%00%ss<PropertyName> |
| | of <UserName>: |
| | <PropertyValue>%7F%7F |
| | PropertyName - Name of the requested property. |
| | UserName - name of the user |
| | %ss - length in characters of the printed message |
| | Get user property (command 61): |
| | %07%01%01N61t%ss<UserName>- |
| | t%ss<PropertyName>t%ss<PropValue> |

AddUser (XML):

| | |
|---|---|
| Request | <AMessage> |
| | <Request> |
| | <Method>AddUser</Method> |
| | <Inst>555555</Inst> |
| | <Params> |
| | <User> |
| | <Name>...</Name> |
| | <Permissions> |
| | <Admin> |
| | <ReadUsers>YES\|NO</ReadUsers> |
| | s> |
| | <WriteUsers>YES\|NO</WriteUsers> |
| | s> |
| | </Admin> |
| | <Service> |
| | <ID>...</ID> |
| | <Read>YES\|NO</Read> |
| | <Write>YES\|NO</Write> |
| | <Execute>YES\|NO</Execute> |
| | </Service> |
| | <Service> |
| | <ID>...</ID> |
| | <Read>YES\|NO</Read> |
| | <Write>YES\|NO</Write> |
| | <Execute>YES\|NO</Execute> |
| | </Service> |
| | ... |
| | </Permissions> |
| | <EMail>...</EMail> |
| | <Host>...</Host> |
| | <Description>...</Description> |
| | ... |
| | </User> |
| | ... |
| | </Params> |
| | </Request> |
| | </AMessage> |
| Response | <AMessage> |
| | <Result> |
| | <Method>AddUser</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

AddUser (Active Message Script—Encoded):

| | |
|---|---|
| Request | %07%01%01N70t%ss<UserName> |
| Response | |

DeleteUser (XML):

| | |
|---|---|
| Request | <AMessage> |
| | <Request> |
| | <Method>DeleteUser</Method> |
| | <Inst>555555</Inst> |
| | <Params> |
| | <Name>...</Name> |
| | </Params> |
| | </Request> |
| | </AMessage> |
| Response | <AMessage> |
| | <Result> |
| | <Method>DeleteUser</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

DeleteUser (Active Message Script—Encoded):

| | |
|---|---|
| Request | %07%01%01N80aID%ss<UserName> |
| Response | |

SendActiveMessage (XML):

| | |
|---|---|
| Request | <AMessage> |
| | <Request> |
| | <Method>SendActiveMessage</Method> |
| | <Inst>555555</Inst> |
| | <Params> |
| | <Addr>...</Addr> |
| | <Script>...</Script> |
| | </Params> |
| | </Request> |
| | </AMessage> |
| Response | <AMessage> |
| | <Result> |
| | <Method>SendActiveMessage</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

SendActiveMessage (Active Message Script—Encoded):

| | |
|---|---|
| Request | %07%01%01NAMt<Size><Addr><Script> |
| Response | No response |

SendMessage (XML):

| | |
|---|---|
| Request | <AMessage> |
| | <Request> |
| | <Method>SendMessage</Method> |
| | <Inst>555555</Inst> |
| | <Params> |
| | <Addr>...</Addr> |
| | <AppID>...<AppID> |
| | <Message>...</Message> |
| | </Params> |
| | </Request> |
| | </AMessage> |
| Response | <AMessage> |
| | <Result> |
| | <Method>SendMessage</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

At least one Addr or AppID (or both) must be specified.

SendMessage (Active Message Script—Encoded):

| | |
|---|---|
| Request | %07%01%01N00t<Size><Addr>...a<ID>%00...<Message> |
| | At least one ‘t’ or ‘a’ (or both) field must be specified. |
| Response | No response |

SaveSettings (XML):

| | |
|---|---|
| Request | <AMessage> |
| | <Request> |
| | <Method>SaveSettings</Method> |
| | <Inst>555555</Inst> |
| | <Params> |
| | </Params> |
| | </Request> |
| | </AMessage> |
| Response | <AMessage> |
| | <Result> |
| | <Method>SaveSettings</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

SaveSettings (Active Message Script—Encoded):

| | |
|---|---|
| Request | %07%01%01N90<Message> |
| Response | No response |

LoadSettings (XML):

| | |
|---|---|
| Request | <AMessage> |
| | <Request> |
| | <Method>LoadSettings</Method> |
| | <Inst>555555</Inst> |
| | <Params> |
| | </Params> |
| | </Request> |
| | </AMessage> |
| Response | <AMessage> |
| | <Result> |
| | <Method>LoadSettings</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

LoadSettings (Active Message Script—Encoded):

| | |
|---|---|
| Request | %07%01%01N91<Message> |
| Response | No response |

StopGateway (XML):

| | |
|---|---|
| Request | <AMessage> |
| | <Request> |
| | <Method>StopGateway</Method> |
| | <Inst>555555</Inst> |
| | <Params> |
| | <RestartIn unit=”min”>120<RestartIn> |
| | </Params> |
| | </Request> |
| | </AMessage> |
| Response | <AMessage> |
| | <Result> |
| | <Method>StopGateway</Method> |
| | <Inst>555555</Inst> |
| | <Value> |
| | <Error> |
| | ERROR_CODE |
| | <Description>...</Description> |
| | </Error> |
| | </Value> |
| | </Result> |
| | </AMessage> |

StopGateway (Active Message Script—Encoded):

| | |
|---|---|
| Request | %07%01%01N92<Message> |
| Response | No response |

In accordance with the practices of persons skilled in the art of computer programming, the present invention is described above with reference to acts and symbolic representations of operations that are performed by various computer systems, including mobile communication devices and “smart cards.” Such acts and operations are sometimes referred to as being computer-executed and may be associated with the operating system or the application program as appropriate. It will be appreciated that the acts and symbolically represented operations include the manipulation by a CPU of electrical signals representing data bits, which causes a resulting transformation or reduction of the electrical signal representation, and the maintenance of data bits at memory locations in a memory system to thereby reconfigure or otherwise alter the computer system operation, as well as other processing of signals. The memory locations where data bits are maintained are physical locations that have particular electrical, magnetic, or optical properties corresponding to the data bits.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. An active messaging system in communication with a short text messaging service of a digital cellular telephone system, comprising:
an active messaging client stored in a computer readable medium of a digital cellular telephone, the active messaging client providing interpretation and execution of an active message script included in a short text message received at the digital cellular telephone by radiant transmission; and
an active message gateway in communication with the short text messaging service to receive short text messages from the digital cellular telephone and selectively forwarding the short text messages according to whether they include an active message script.

2. The system of claim 1 in which the active messaging client includes an active messaging loader that distinguishes and directs short text messages according to whether they include an active message script.

3. The system of claim 2 in which each short text message includes a header and the short text messages that have an active message script include an indication of the active message script in the header.

4. The system of claim 2 in which the active messaging client includes an active message interpreter to which the active messaging loader directs short text messages that include an active message script, the active message interpreter providing interpretation and execution of the active message script.

5. The system of claim 2 in which the active messaging client includes an active message file manager to which the active messaging loader directs short text messages that include an active message script, the active message file manager providing storage of the active message script in a file system included on the digital cellular telephone.

6. The system of claim 1 in which the active messaging client includes an active message interpreter that receives the active message script and provides interpretation and execution of the active message script.

7. The system of claim 1 in which the active messaging client includes an active message file manager that receives the active message script and provides storage of the active message script in a file system included on the digital cellular telephone.

8. The system of claim 1 further comprising one or more application servers in communication with the active message gateway, each of the one or more application servers providing an active message application or service in response to a request directed from the digital cellular telephone.

9. The system of claim 8 in which the active message gateway includes an active messaging connector service that provides communication between the short text messaging service and one or more active message service interfaces to the one or more application servers.

10. In a computer readable medium of a digital cellular telephone, active messaging client software for active messages transmitted via a short text messaging service, comprising:
active messaging loader software that distinguishes and directs short text messages according to whether they include an active message script; and
active message interpreter software to which the active messaging loader directs short text messages that include an active message script, the active message interpreter providing interpretation and execution of the active message script.

11. The medium of claim 10 in which each short text message includes a header and the short text messages that have an active message script include an indication of the active message script in the header.

12. The medium of claim 10 further including active message file manager software to which the active messaging loader directs short text messages that include an active message script, the active message file manager providing storage of the active message script in a file system included on the computer readable medium.

13. The medium of claim 10 in which the digital cellular telephone includes a subscribed identity module with a computer readable medium and in which the active messaging loader software and the active message interpreter software are stored on the computer readable medium of the subscriber identity module.

14. The medium of claim 10 in which active message interpreter includes a global string buffer (GB) that is used for building character strings and a last result buffer (LRB) that is used for storing a most recent result.

15. The medium of claim 10 in which the active message script includes text strings and jumps, wherein all text strings are prefixed with their byte-size and all jumps are made to specific byte locations within the script.

16. The medium of claim 10 in which active message script are a format:
<Instruction><Flags>[<Data>][<Address>]
wherein <Instruction> specifies a command to be executed, <Flags> specifies one or more options for the command, <Data> specifies any data associated with the command, and <Address> is a byte-address of an instruction to be executed under predefined conditions related to the command.

17. In a computer readable medium of a digital cellular telephone, an active message script data structure for active messages transmitted via a short text messaging service, comprising:
<Instruction><Flags>[<Data>][<Address>]
wherein <Instruction> field specifies a command to be executed, <Flags> field specifies one or more options for the command, <Data> field specifies any data associated with the command, and <Address> field is a byte-address of an instruction to be executed under predefined conditions related to the command.

18. The medium of claim 17 further including a print instruction associated with the instruction field for printing a text string, destination flags associated with the flag field specifying whether the text string is to be printed to from a memory buffer, and a text string associated with the data field and representing the text string to be printed.

19. The medium of claim 17 further including an input instruction associated with the instruction field for printing a text string and requesting input from a user, content identification flags associated with the flag field optionally specifying the text string is to be printed, and a text string associated with the data field and optionally representing the text string to be printed.

20. The medium of claim 17 further including a select instruction associated with the instruction field for printing a plurality of text strings, destination flags associated with the flag field specifying a location to which a user selection is to be returned, and plural text strings associated with the data field and representing the plural text string to be printed.

21. The medium of claim 17 further including a condition instruction associated with the instruction field for comparing a pair of condition strings and jumping to a specified address when the pair of condition strings satisfies a predefined condition, flags associated with the flag field optionally specifying one of the condition strings and optionally specifying the predefined condition, and a text string associated with the data field and optionally representing one of the condition strings.

22. The medium of claim 17 further including a send message instruction associated with the instruction field for transmitting a short text message, destination flags associated with the flag field optionally specifying a destination for the short text message, and a text string associated with the data field and optionally specifying a destination for the short text message.

23. The medium of claim 17 further including a call instruction associated with the instruction field for initiating a telephone call, destination flags associated with the flag field optionally specifying a telephone number for the telephone call, and a text string associated with the data field and optionally specifying a telephone number for the telephone call.

24. The medium of claim 17 further including a location instruction associated with the instruction field for obtaining location information about a location of the digital cellular telephone, and a destination flag associated with the flag field optionally specifying where the location information is to be stored.

25. The medium of claim 17 further including an execute instruction associated with the instruction field for initiating execution of an active message file stored on the digital cellular telephone, a file identification flag associated with the flag field optionally identifying the active message file to be executed, and a text string associated with the data field and optionally identifying the active message file to be executed.

26. The medium of claim 17 further including an execute instruction associated with the instruction field for initiating execution of an active message file stored on the digital cellular telephone, a file identification flag associated with the flag field optionally identifying the active message file to be executed.

27. The medium of claim 17 further including a goto instruction associated with the instruction field for directing execution of the active message script to jump to a specified byte location in the script, and a byte address flag associated with the address field for identifying the byte location for the script to jump to.

28. The medium of claim 17 further including an addressbook instruction associated with the instruction field for directing retrieval of information from an addressbook stored on the digital cellular telephone, and an addressbook entry flag associated with the flag field for specifying one or more addressbook entries to be retrieved.

29. The medium of claim 17 further including an application instruction associated with the instruction field for identifying an application to be utilized by another service.

30. In a mobile telephone short text messaging system, an active message gateway method for short text messages that include an active message script, comprising:
receiving at an active message gateway short text messages transmitted from a mobile telephone;
distinguishing among the short text messages ones that include an active message script from ones that do not include an active message script, the short text messages that do not include an active message script including destination addresses corresponding to short text messaging destinations;
forwarding the short text messages that do not include an active message script to the short text messaging destinations corresponding to the destination addresses;
interpreting the active message script in the short text messages that include it and transmitting any corresponding response.

31. The method of claim 30 further comprising authenticating that the mobile telephone is associated with the active message gateway prior to interpreting the active message script.

32. The method of claim 30 further comprising:
determining whether the active message script is to be executed locally by the active message gateway or remotely by an application server that is in computer network communication with the active message gateway; and
executing the active message script at the active message gateway or the remote application server according to the determination.

33. The method of claim 32 wherein the active message script is executed at the remote application server, the method further comprising re-formatting the active message script at the active message gateway before transmitting the active message script to the remote application server for execution.

34. The method of claim 33 in which the active message script is re-formatted into an XML file format.

35. The method of claim 30 further comprising:
determining whether the active message script is to be executed locally by the active message gateway or remotely by another mobile telephone; and
executing the active message script at the active message gateway or at the other mobile telephone according to the determination.

36. In a computer readable medium of a mobile telephone short text messaging system, active message gateway software for short text messages that include an active message script, comprising:
software for receiving at an active message gateway short text messages transmitted from a mobile telephone;
software for distinguishing among the short text messages ones that include an active message script from ones that do not include an active message script, the short text messages that do not include an active message script including destination addresses corresponding to short text messaging destinations;
software for forwarding the short text messages that do not include an active message script to the short text messaging destinations corresponding to the destination addresses;
software for interpreting the active message script in the short text messages that include it and transmitting any corresponding response.

37. The medium of claim 36 further comprising software for authenticating that the mobile telephone is associated with the active message gateway prior to interpreting the active message script.

38. The medium of claim 36 further comprising:
software for determining whether the active message script is to be executed locally by the active message gateway or remotely by an application server that is in computer network communication with the active message gateway; and
software for executing the active message script at the active message gateway or the remote application server according to the determination.

39. The medium of claim 38 wherein the active message script is executed at the remote application server, the method further comprising software for re-formatting the active message script at the active message gateway before transmitting the active message script to the remote application server for execution.

40. The medium of claim 39 in which the active message script is re-formatted into an XML file format.

41. The medium of claim 36 further comprising:
software for determining whether the active message script is to be executed locally by the active message gateway or remotely by another mobile telephone; and
software for executing the active message script at the active message gateway or at the other mobile telephone according to the determination.

42. The medium of claim 36 further comprising a GetServiceList active message command data structure that returns to the mobile telephone a list of services available through the active message gateway.

43. The medium of claim 36 further comprising a GetService active message command data structure that provides a request for a particular service via the active message gateway.

44. The medium of claim 36 further comprising an InstallService active message command data structure that functions to obtain active message script for a service and install the active message script on the mobile telephone.

45. The medium of claim 36 further comprising a GetUserList active message command data structure that returns a list of users available through the active message gateway.

46. The medium of claim 36 further comprising a GetUser active message command data structure that returns information about or establishes a connection with a user available through the active message gateway.

47. The medium of claim 36 further comprising an AddUser active message command data structure that adds a designated user to a list of selected users maintained in association with the mobile telephone.

48. The medium of claim 36 further comprising a DeleteUser active message command data structure that deletes a user from a list of selected users maintained in association with the mobile telephone.

49. The medium of claim 36 further comprising a SendActiveMessage active message command data structure that sends a short text message that includes active message script.

50. The medium of claim 36 further comprising a SendMessage active message command data structure that sends a short text message that does not include active message script.
